(19) United States
(12) Patent Application Publication
(10) Pub. No.: US 2015/0122969 A1
(43) Pub. Date: May 7, 2015

(54) SEISMIC ISOLATION STRUCTURE FOR HEAVY OBJECTS, AND SEISMIC ISOLATION METHOD

(71) Applicant: ANSHIN CO., LTD., Aichi (JP)

(72) Inventors: Kikuo Sugita, Aichi (JP); Shinji Murase, Aichi (JP)

(21) Appl. No.: 14/380,562

(22) PCT Filed: Feb. 21, 2013
(86) PCT No.: PCT/JP2013/000992

§ 371 Date: Dec. 10, 2014

(30) Foreign Application Priority Data
Feb. 22, 2012 (JP) 2012-036034

(51) Int. Cl. F16F 15/023; F16M 13/00; F16F 15/22

(52) U.S. Cl. CPC F16F 15/023; F16F 15/22; F16M 13/00
USPC 248/562

(57) ABSTRACT

[Problem] To prevent, using a simple seismic isolation structure, vibration, noise, and toppling of a heavy object installed on a floor surface where anchor bolts cannot be used.

[Solution] In a seismic isolation structure 11 for a machine 1, plastically deformable support bodies 16 are embedded in a gel-like elastic body 15 of a vibration-damping pad 12. A bottom-surface adhesive layer of the gel-like elastic body 15 is bonded to the floor surface, and a pressurizing plate 13 is bonded to a top-surface adhesive layer of the gel-like elastic body 15. The pressurizing plate 13 bears weight of the machine 1 and uniformly applies pressure to the entire vibration-damping pad 12. The base 21 of a holder 14 is welded to the upper surface of the pressurizing plate 13; a bolt 22 erected on the base 21 is caused to penetrate a through-hole 3 of a leg section 2; and the leg section 2 is restrained on the pressurizing plate 13 by the holder 14 from moving laterally.

### FIELD OF THE INVENTION

The present invention relates to seismic isolation structures and seismic isolation methods for preventing vibration, noise, and toppling, due to an earthquake, of a variety of heavy objects, such as machines, tanks, showcases, etc., installed on floor surfaces.

Conventionally, facilities installed in factories, etc., are typically secured to the floor surfaces with anchor bolts. For example, the machine 51 shown in FIG. 12 is installed via nuts 54 on a concrete floor surface F with anchor bolts 53 that penetrate leg portions 52. However, there are types of heavy objects for which anchor bolts 53 cannot be used as means for preventing their toppling. For example, as shown in FIG. 13, a tank 55 for storing drinking water is held in an elevated location on a pedestal 56 due to hygiene requirements. The leg sections 57 of the pedestal 56 are supported on a waterproof floor surface F via metal floor plates 58 to facilitate relocation when the manufacturing lines are modified.

Additionally, seismic isolation structures with vibration-proof rubber interposed between the equipment and the floor surfaces are widely used for the ease of their installation. Patent Document 1 proposes a technology for preventing toppling of a gravestone by embedding spherical bodies in elastic sheets, interposing the elastic sheets between the middle stone and the headstone, and allowing plastic deformation of the spherical bodies to efficiently absorb the vibrations of an earthquake.

### PRIOR ART DOCUMENTS

### Patent Documents

Patent Document 1: Japanese Patent No. 4238277

### SUMMARY OF THE INVENTION

### Problems to Be Solved by the Invention

Conventional seismic isolation structures using anchor bolts, however, are not only inapplicable to waterproof floor surfaces or transportable heavy objects but also require large-scale earthquake-proof works for existing heavy objects. According to the conventional seismic isolation structures using vibration-proof rubber, a lateral vibration of earthquakes causes the leg sections of heavy objects to slide laterally, which stops the vibration-proof rubber from performing in a short period of time, resulting in toppling of the heavy objects.

In view of the above, the object of the present invention is to provide seismic isolation structures and methods broadly applicable to a variety of floor surfaces and heavy objects while improving the vibration, noise, and seismic performance of existing heavy objects through simple installation work. Means to Solve the Problem

In order to solve the above-identified problem, the present invention provides the following seismic isolation structures and methods:

(1) A seismic isolation structure characterized by comprising: a vibration-damping pad having at least one plastically deformable support body embedded in a gel-like elastic body; and a pressurizing plate that bears weight of a heavy object to apply pressure to the vibration-damping pad, wherein the vibration-damping pad is set on a floor surface, the pressurizing plate is joined to the vibration-damping pad; and a holder is provided on the pressurizing plate for restraining a leg section of the heavy object from moving laterally.

(2) A seismic isolation structure characterized in that a restraint wall is provided under the pressurizing plate such that the restraint wall surrounds the vibration-damping pad, a caulking compound is packed outside of the restraint wall and between the pressurizing plate and the floor surface, and a gap is formed within the restraint wall and between the pressurizing plate and the floor surface for permitting deformation of the gel-like elastic body.

(3) A seismic isolation structure characterized in that the restraint wall is formed in the shape of a ring and kept on an undersurface of the pressurizing plate.

(4) A seismic isolation structure characterized in that the gel-like elastic body is provided with an adhesive layer on top and bottom surfaces thereof, the bottom-surface adhesive layer bonding the vibration-damping pad to the floor surface and the top-surface adhesive layer bonding the pressurizing plate to the vibration-damping pad.

(5) A seismic isolation structure characterized in that the holder includes a bolt that penetrates a leg section of the heavy object and a nut is in threading engagement with the bolt for adjusting the height of the leg section.

(6) A seismic isolation structure characterized in that the holder is clamped to the pressurizing plate by arcuate members with a vibration-proof rubber interposed between the holder and the pressurizing plate.

(7) A seismic isolation structure characterized in that the holder includes a columnar member that surrounds a leg section of the heavy object.

(8) A seismic isolation method characterized by comprising the steps of: preparing a vibration-damping pad having at least one plastically deformable support body embedded in a gel-like elastic body; preparing a pressurizing plate for applying pressure to the vibration-damping pad; setting the vibration-damping pad on a floor surface; joining the pressurizing plate to a surface of the vibration-damping pad; mounting a leg section of a heavy object on the pressurizing plate; allowing a load of the heavy object to apply pressure to the vibration-damping pad via the pressurizing plate; preventing the heavy object from sliding laterally by connecting a holder provided on the pressurizing plate to the leg section of the heavy object.

(9) A seismic isolation method characterized by comprising the steps of: arranging a restraint wall under the pressurizing plate such that the restraint wall surrounds the vibration-damping pad, prior to mounting a leg section of a heavy object; and after mounting the leg section of the heavy object, packing a caulking compound outside of the restraint wall and between the pressurizing plate and the floor surface and forming a gap within the restraint wall and between the pressurizing plate and the floor surface for permitting deformation of the gel-like elastic body.

(10) A seismic isolation method characterized in that the restraint wall is formed in the shape of a ring and disposed around the vibration-damping pad while being kept on an underside of the pressurizing plate.

(11) A seismic isolation method characterized in that in the step of setting the vibration-damping pad, a bottom-surface adhesive layer of the gel-like elastic body is bonded to the floor surface and in the step of joining the pressurizing plate, the pressurizing plate is bonded to a top-surface adhesive layer of the gel-like elastic body.

(12) A seismic isolation method characterized in that the step of preventing the heavy object from sliding laterally includes the steps of connecting a bolt provided in the holder to the leg section of the heavy object and adjusting the height of the leg section with a nut in threading engagement with the bolt.

### Effect of the Invention

According to the seismic isolation structures and methods of the present invention, the vibration-damping pad effectively absorbs vibration of a heavy object using the combination of the gel-like elastic body and the plastically deformable support body. This eliminates the need for using anchor bolts, making the seismic isolation structures broadly applicable to a variety of floor surfaces and heavy objects while improving the vibration-proof, sound-proof, and seismic performance of existing heavy objects through simple installation work. Furthermore, as the holder restrains the leg section of the heavy object on the pressurizing plate, the effect of preventing the heavy object from sliding laterally due to a lateral vibration and ensuring that the vibration-proof rubber performs for a long period of time during an earthquake are also achieved.

### BRIEF DESCRIPTION OF THE DRAWINGS

FIG. 1 is a perspective view of a seismic isolation structure representing Embodiment 1 of the present invention;

FIG. 2 is a perspective exploded view showing the seismic isolation structure of FIG. 1.

FIG. 3 is a cross-sectional view showing a procedure to install the seismic isolation structure of FIG. 1.

FIG. 4 shows a perspective view showing a vibration-damping pad that is different from that of FIG. 2 and a cross-sectional view showing a seismic isolation structure using that pad.

FIG. 5 is a perspective exploded view of a seismic isolation structure representing Embodiment 2 of the present invention.

FIG. 6 is a cross-sectional view showing the seismic isolation structure of FIG. 5 fitted on a leg section of a heavy object.

FIG. 7 is a perspective exploded view of a seismic isolation structure representing Embodiment 3 of the present invention.

FIG. 8 is a cross-sectional view showing the seismic isolation structure of FIG. 7 fitted on a leg section of a heavy object.

FIG. 9 is a cross-sectional view of a seismic isolation structure representing Embodiment 4 of the present invention.

FIG. 10 shows a perspective view and a partially cross-sectional view of a seismic isolation structure representing a modification of Embodiment 1;

FIG. 11 is a perspective view of a seismic isolation structure representing a modification of Embodiment 2;

FIG. 12 is a perspective view that shows a prior art using anchor bolts.

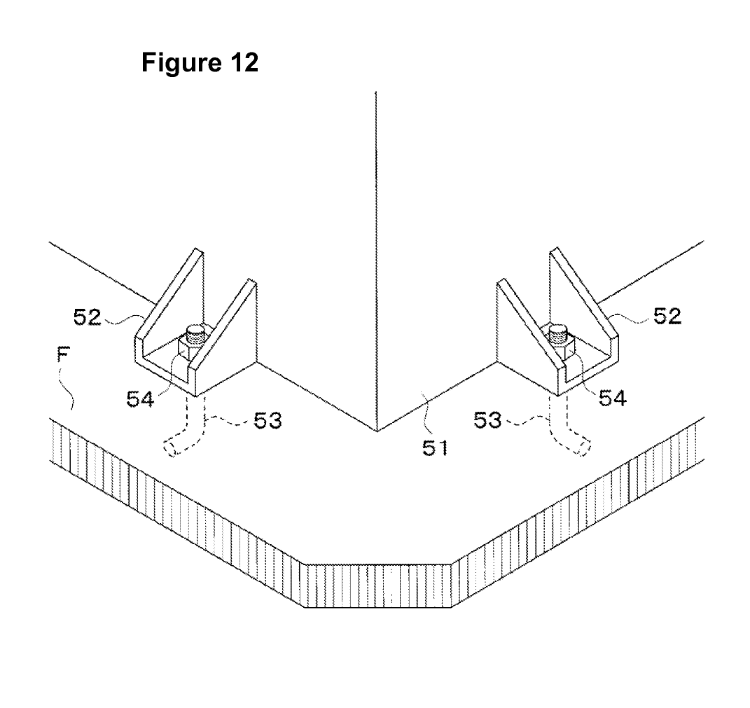

FIG. 13 is an elevation view that shows a prior art that use no anchor bolts.

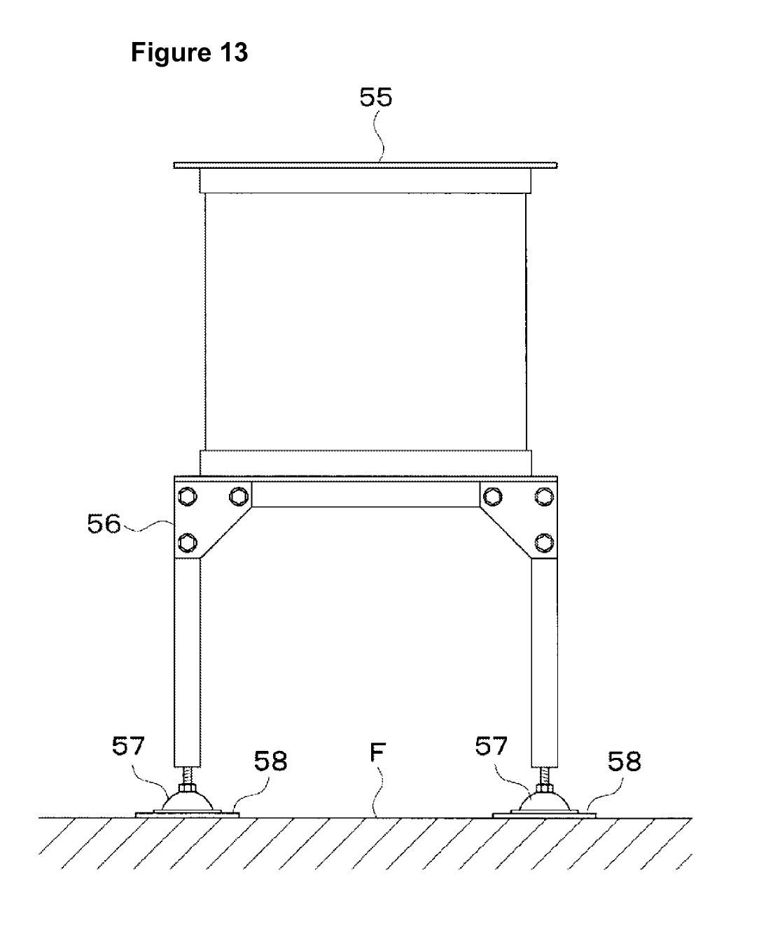

### MODES TO CARRY OUT THE INVENTION

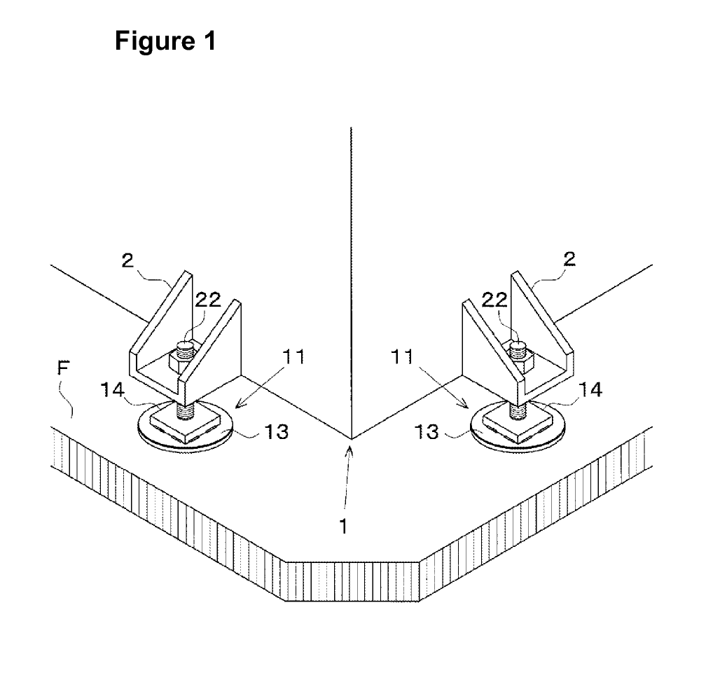

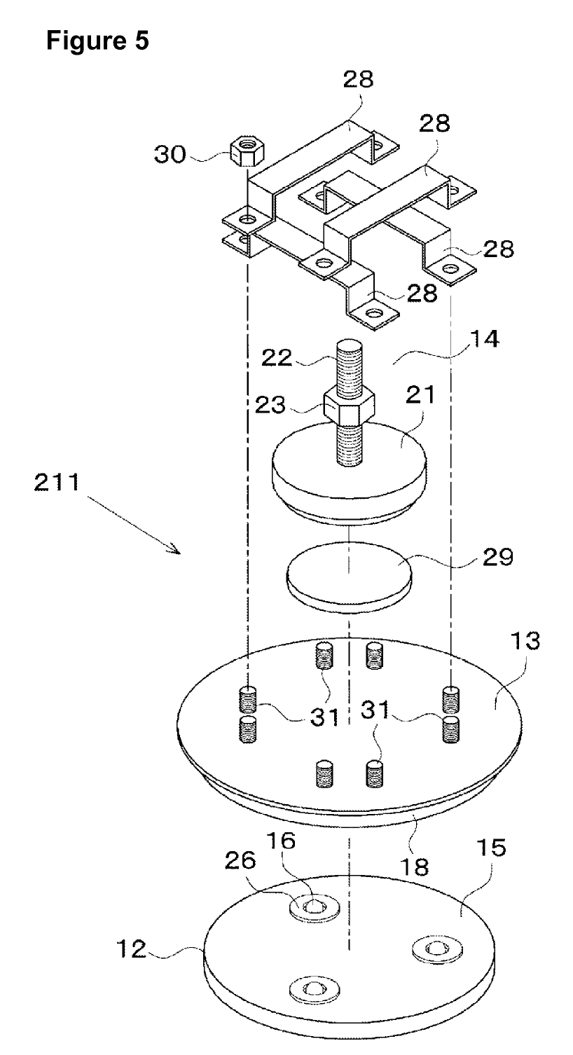

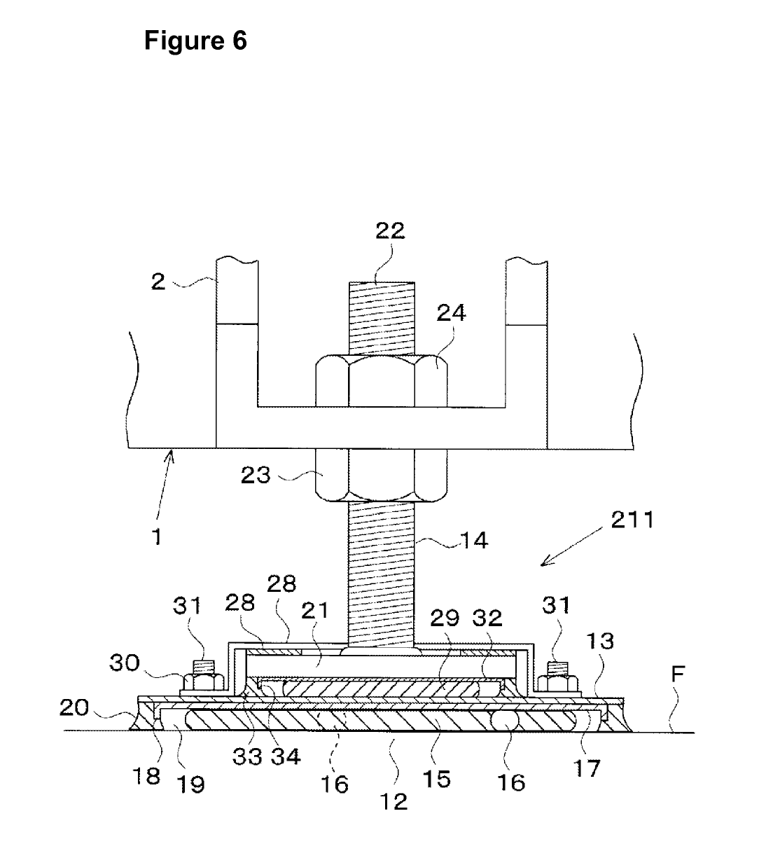

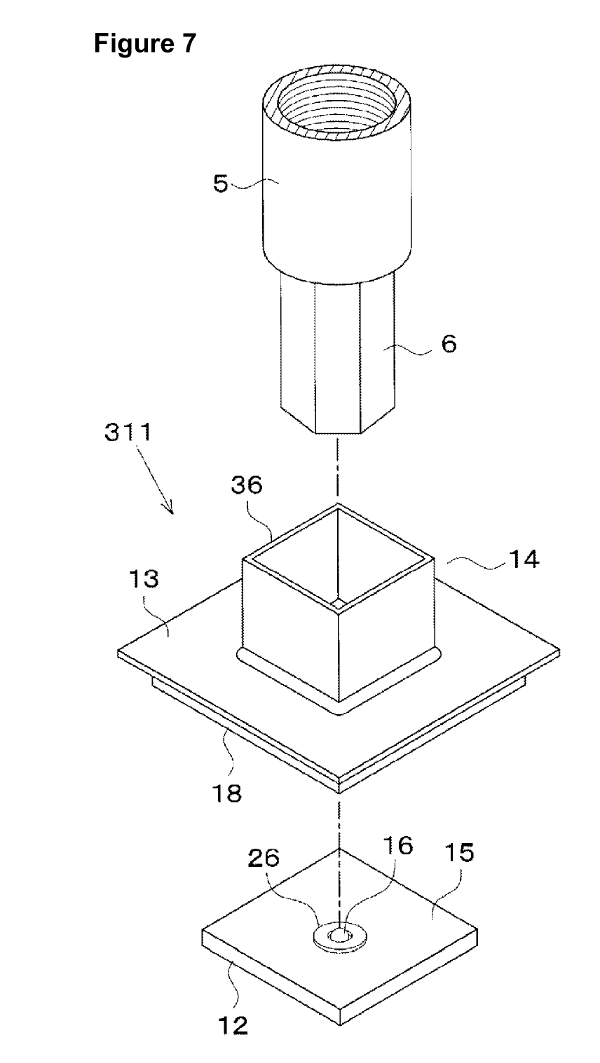

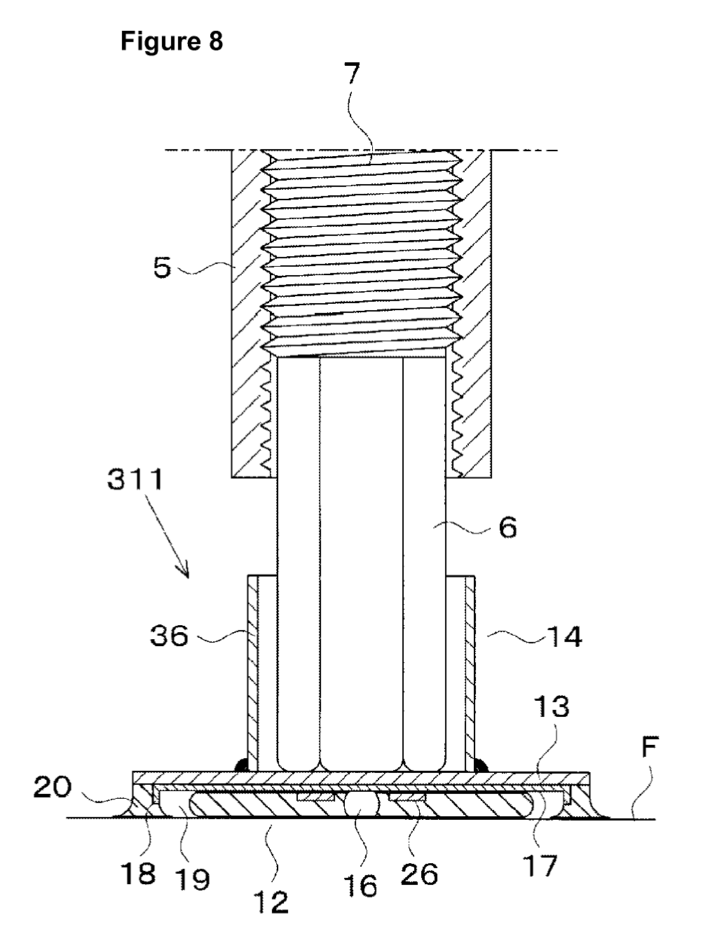

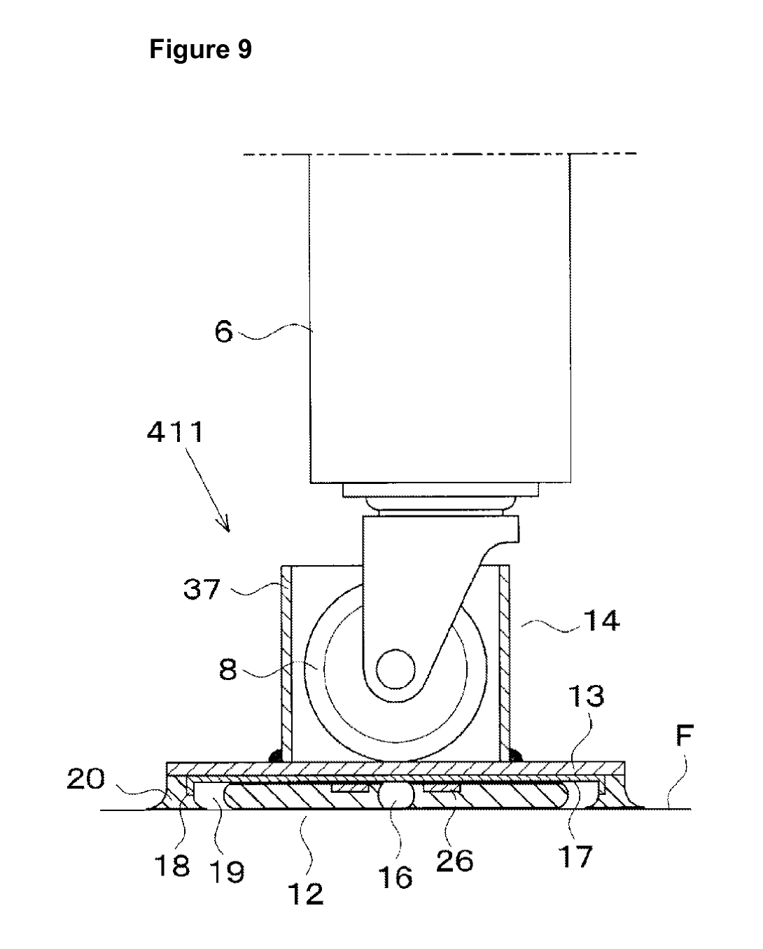

Embodiments of the present invention will be described hereinafter with reference to the drawings, in which: FIGS. 1-4 show seismic isolation structures 11 of Embodiment 1;FIGS. 5 and 6 show a seismic isolation structure 211 of Embodiment 2;FIGS. 7 and 8 show a seismic isolation structure 311 of Embodiment 3;and FIG. 9 shows a seismic isolation structure 411 of Embodiment 4.In each of the views, identical symbols designate identical or similar elements.

### Embodiment 1

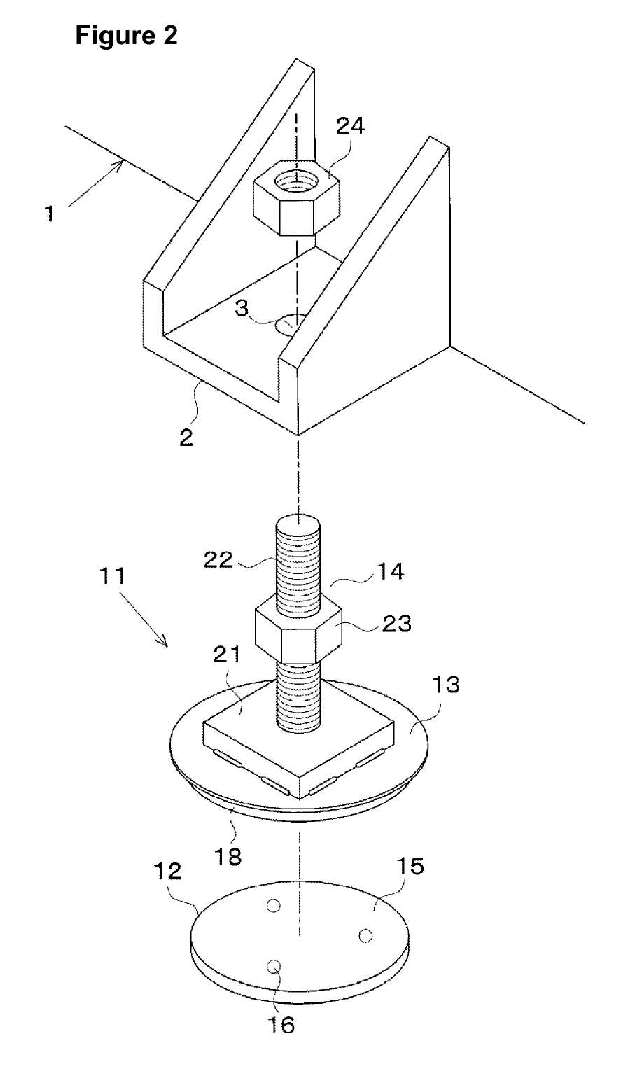

As shown in FIGS. 1 and 2, the seismic isolation structures 11 of Embodiment 1 are provided between a machine 1, which is a heavy object, and a floor surface F. The machine 1 includes a plurality of leg portions 2, whereas the seismic isolation structures 11 include mechanisms for adjusting the heights of the leg portions 2 with respect to the floor surface F. The seismic isolation structures 11 are provided with vibration-damping pads 12 (see FIG. 2) set on the floor surface F, pressurizing plates 13 that press against the vibration-damping pads 12, and holders 14 that restrain the leg portions 2 of the machine 1 on the pressurizing plates 13.

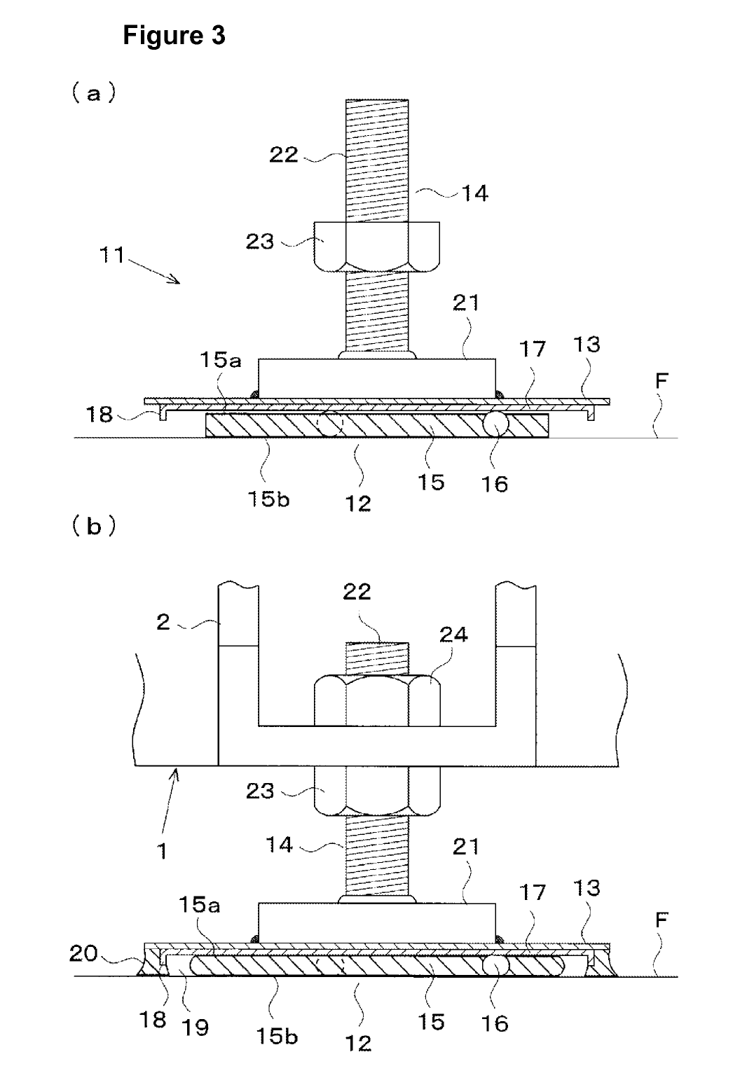

As shown in FIGS. 2 and 3, a vibration-damping pad 12 is comprised of a gel-like elastic body 15 having elasto-viscosity and plastically deformable support bodies 16. The gel-like elastic body 15 is formed of a transparent or translucent polymeric material in a circular shape. Adhesive layers 15a and 15b (see FIG. 3) are provided on the bottom and top surfaces of the gel-like elastic body 15, such that the vibration-damping pad 12 is bonded to the floor surface F by the bottom-surface adhesive layer 15b and the pressurizing plate 13 is bonded to the vibration-damping pad 12 by the top-surface adhesive layer 15a.

The support bodies 16 are formed in a spherical shape having a diameter slightly greater than the thickness of the gel-like elastic body 15, and, for example, three support bodies 16 are embedded at equiangular positions in each gel-like elastic body 15. When the vibration-damping pad 12 is in its natural state (see FIG. 3a), top portions of the support bodies 16 are exposed above the top-surface adhesive layer 15a of the gel-like elastic body 15, and when the vibration-damping pad 12 is under pressure (see FIG. 3b), the support bodies 16 are compressed to the same height as the thickness of the gel-like elastic body 15.

The pressurizing plate 13 is formed of stainless steel in a circular shape having a larger area than that of the vibration-damping pad 12 and adapted to bear weight of the machine 1 to compress the entire vibration-damping pad 12 with a uniform force. A reinforcement plate 17 also made of stainless steel is welded to the bottom surface of the pressurizing plate 13. The reinforcement plate 17 is formed in a circular shape having a diameter greater than that of the vibration-damping pad 12 and smaller than that of the pressurizing plate 13, and a restraint wall 18 projects downward from the reinforcement plate 17 along its circumference.

Formed within the restraint wall 18 is a gap 19 that permits radial deformation of the vibration-damping pad 12. Packed outside of the restraint wall 18 is a caulking compound 20 for sealing the opening between the outer periphery of the pressurizing plate 13 and the floor surface F. The restraint wall 18 prevents the caulking compound 20 from entering the gap 19 so as not to impede the deformation of the vibration-damping pad 12. Note that the restraint wall 18 is formed with such a height that the wall does not come into contact with the floor surface F even when the vibration-damping pad 12 is compressed.

The holder 14 is comprised of a base 21, a bolt 22, an adjustment nut 23, and a lock nut 24. The base 21 is secured by welding to the pressurizing plate 13 and the bolt 22 is erected at the center of the base 21. The top end of the bolt 22 penetrates the through-hole 3 of the leg section 2 (see FIG. 2) to restrain the leg section 2 on the pressurizing plate 13 from moving laterally. The adjustment nut 23 and the lock nut 24 are in threading engagement with the bolt 22 above and below the leg section 2 so as to permit adjustment of the height of the leg section 2.

To install the seismic isolation structure 11, first, as shown in FIG. 3(a), the bottom-surface adhesive layer 15b of the vibration-damping pad 12 is bonded to the floor surface F, and the pressurizing plate 13 is bonded to the top-surface adhesive layer 15a of the vibration-damping pad 12. Next, as shown in FIG. 3(b), the bolt 22 is passed through the leg section 2, and after the height is adjusted with the nuts 23 and 24, the leg section 2 is restrained with the holder 14. In this way, the vibration-proof, sound-proof, and seismic performance of the existing machine 1 can be improved through very simple installation work without using anchor bolts. Furthermore, as the vibration-damping pad 12 absorbs vibration of the equipment, loosening of screws, wear, and damage can be effectively controlled. In particular, the circumference of the vibration-damping pad 12 can be sealed with the caulking compound 20 to prevent entry of rubbish and impurities, thus keeping the area surrounding the leg section 2 in a hygienic condition.

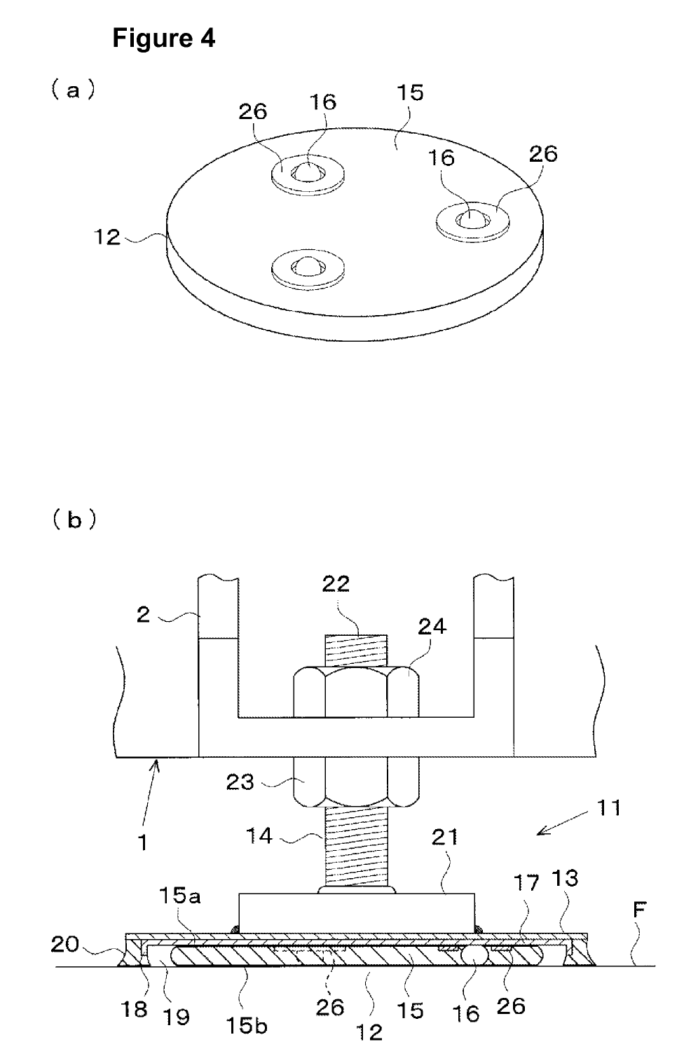

According to the seismic isolation structure 11 shown in FIG. 4, circular rings 26 made of a metal or resin material are embedded in the gel-like elastic body 15 of a vibration-damping pad 12, and support bodies 16 are disposed in the rings 26. According to this structure, the support bodies 16 are firmly supported by the rings 26 at equiangular positions in the gel-like elastic body 15, thus maintaining the vibration-absorbing performance of the vibration-damping pad 12 for a long period of time.

### Embodiment 2

In the seismic isolation structure 211 shown in FIGS. 5 and 6, the base 21 of the holder 14 is clamped to the pressurizing plate 13 by four arcuate members 28 with a vibration-proof rubber 29 interposed between the base 21 and the pressurizing plate 13. The arcuate members 28 are assembled to intersect one another and fastened to bolts 31 provided on the pressurizing plate 13 with nuts 30. Bonded to the under surface of the base 21 is an intermediate plate 32 that is provided with a restraint wall 34 formed along the circumference thereof for blocking a caulking compound 33. Additionally, the vibration-proof rubber 29 is disposed within the restraint wall 34 such that the two upper and lower tiers of elastic members comprised of the vibration-proof rubber 29 and the vibration-damping pad 12 can provide improved vibration absorption.

### Embodiment 3

According to the seismic isolation structure 311 shown in FIGS. 7 and 8, the holder 14 includes a columnar member 36 surrounding a leg section 6 of a heavy object 5, and the leg section 6 is restrained on the pressurizing plate 13 by the columnar member 36 from moving laterally. The leg section 6 is attached to the heavy object 5 (only a part thereof is shown) in such a manner as to allow adjustment of its height with a screw 7, and the leg section 6 is also removably inserted in the columnar member 36. Accordingly, the seismic isolation structure 311 of Embodiment 3 is preferably applicable to heavy objects, such as tool benches and showcases, that are relatively light in weight and need to be transportable. Note that in the illustrated vibration-damping pad 12, a single support body 16 and a single ring 2 are embedded at the center of the gel-like elastic body 15.

### Embodiment 4

According to the seismic isolation structure 411 of Embodiment 4 shown in FIG. 9, the holder 14 includes a columnar member 37 surrounding a wheel 8 of a leg section 6, and the wheel 8 is restrained on the pressurizing plate 13 by the columnar member 37 from rolling laterally. Therefore, in particular, the seismic isolation structure 411 of Embodiment 4 can prevent a transportable heavy object provided with wheels 8 from rolling out of control due to an earthquake.

The present invention is not limited to the foregoing embodiments and, as illustrated below, can still be carried out with the shapes and structures of various components altered as required, without deviating from the spirit of the present invention:

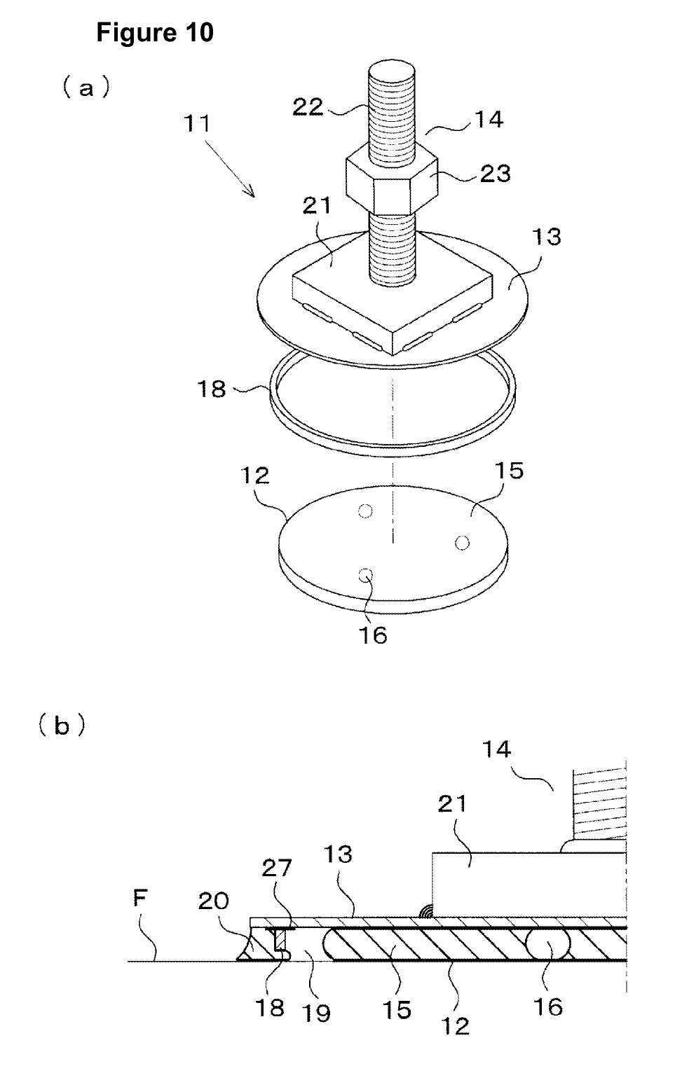

(1) In the seismic isolation structure 11 of Embodiment 1, the reinforcement plate 13 (see FIG. 3) may be omitted while providing the restraint wall 18 in the shape of a ring detached from the pressurizing plate 13 as shown in FIG. 10. To carry out installation, the vibration-damping pad 12 is bonded to the floor surface F, and the restraint wall 18 is kept on the undersurface of the pressurizing plate 13 with a double-sided tape 27 so as to surround the vibration-damping pad 12 from outside. Then, the pressurizing plate 13 is bonded to the vibration-damping pad 12, and a caulking compound 20 is packed in the opening between the pressurizing plate 13 and the floor surface F such that the restraint wall 18 can block the compound. This will provide an effect equivalent to that of Embodiment 1 with a simpler and more inexpensive structure.

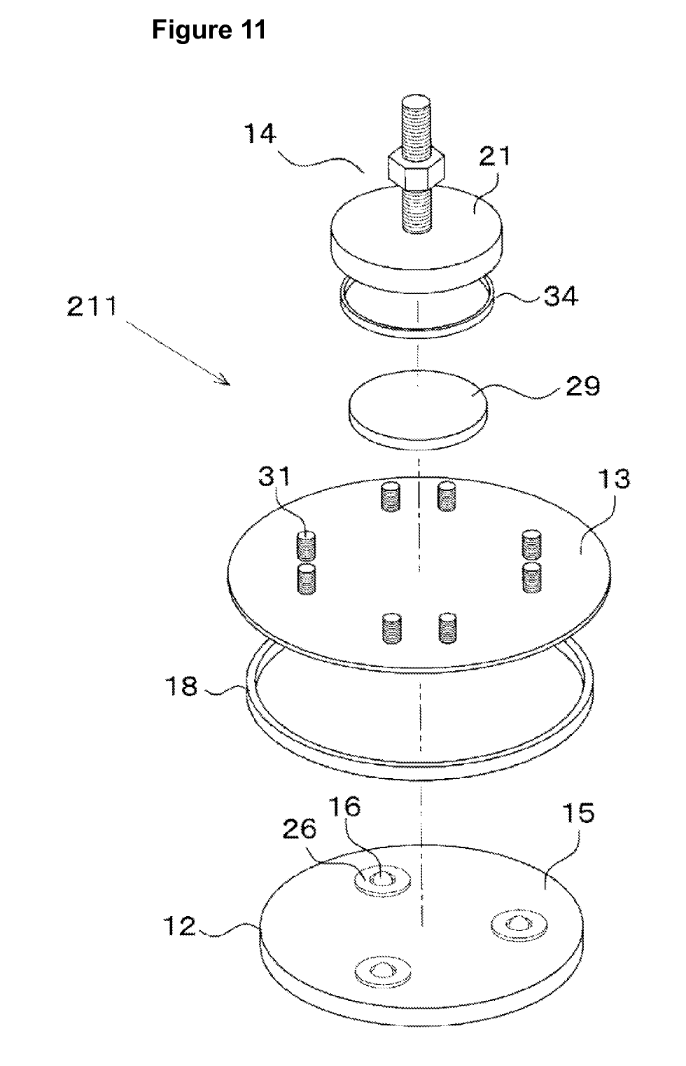

(2) In the seismic isolation structure 211 of Embodiment 2, both of the reinforcement plate 13 and the intermediate plate 32 (see FIG. 6) may be omitted while providing the two restraint walls 18 and 34 both in the shape of a ring as separate members from the pressurizing plate 13 and the holder 14 as shown in FIG. 11 so as to block the caulking compounds 20 and 33 (see FIG. 6) with the restraint walls 18 and 34. This structure will also provide an effect equivalent to that of Embodiment 2 with a more inexpensive structure.

(3) In the seismic isolation structure 311 of Embodiment 3 (see FIG. 8) and the seismic isolation structure 411 of Embodiment 4 (see FIG. 9), the reinforcement plates 17 may be omitted while providing the restraint walls 18 in the shape of a ring as described in Item (1) above.

(4) The shapes and structures of any other components may also be modified to suit the particular application of the seismic isolation structure.

1: Heavy object

2: Leg section

11: Seismic isolation structure

12: Vibration-damping pad

13: Pressurizing plate

14: Holder

15: Gel-like elastic body

16: Support body

22: Bolt

23: Adjustment nut

28: Arcuate member

29: Vibration-proof rubber

F: Floor surface

1. A seismic isolation structure, comprising:
a vibration-damping pad having at least one plastically deformable support body embedded in a gel-like elastic body; and
a pressurizing plate that bears weight of a heavy object via a leg section of the heavy object to apply pressure to the gel-like elastic body and the at least one support body of the vibration-damping pad,
wherein the vibration-damping pad is on a floor surface, the pressurizing plate is joined to the vibration-damping pad, and a holder is provided on the pressurizing plate for restraining the leg section of the heavy object from moving laterally.

2. A seismic isolation structure in accordance with claim 1, wherein a restraint wall is provided under the pressurizing plate such that the restraint wall surrounds the vibration-damping pad, a caulking compound is packed outside of the restraint wall and between the pressurizing plate and the floor surface, and a gap is formed within the restraint wall and between the pressurizing plate and the floor surface for permitting deformation of the gel-like elastic body.

3. A seismic isolation structure in accordance with claim 2, wherein the restraint wall is formed in the shape of a ring and kept on an underside of the pressurizing plate.

4. A seismic isolation structure in accordance with claim 1, wherein the gel-like elastic body is provided with an adhesive layer on top and bottom surfaces thereof, the bottom-surface adhesive layer bonding the vibration-damping pad to the floor surface and the top-surface adhesive layer bonding the pressurizing plate to the vibration-damping pad.

5. A seismic isolation structure in accordance with claim 1, wherein the holder includes a bolt that penetrates a leg section of the heavy object and a nut is in threading engagement with the bolt for adjusting the height of the leg section.

6. A seismic isolation structure in accordance with claim 1, wherein the holder is clamped to the pressurizing plate by arcuate members with a vibration-proof rubber interposed between the holder and the pressurizing plate.

7. A seismic isolation structure in accordance with claim 1, wherein the holder includes a columnar member that surrounds the leg section of the heavy object.

8. A seismic isolation method, comprising the steps of:
providing a vibration-damping pad having at least one plastically deformable support body embedded in a gel-like elastic body;
providing a pressurizing plate for applying pressure to the vibration-damping pad;
setting the vibration-damping pad on a floor surface;
joining the pressurizing plate to a surface of the vibration-damping pad;
mounting a leg section of a heavy object on the pressurizing plate;
allowing a load of the heavy object to apply pressure to the gel-like elastic body and the at least one support body of the vibration-damping pad via the pressurizing plate; and
restraining the leg section of the heavy object from moving laterally relative to the pressurizing plate by connecting a holder provided on the pressurizing plate to the leg section of the heavy object.

9. A seismic isolation method in accordance with claim 8, comprising the steps of:
arranging a restraint wall under the pressurizing plate such that the restraint wall surrounds the vibration-damping pad, prior to mounting a leg section of a heavy object; and
after mounting the leg section of the heavy object, packing a caulking compound outside of the restraint wall and between the pressurizing plate and the floor surface and forming a gap within the restraint wall and between the pressurizing plate and the floor surface for permitting deformation of the gel-like elastic body.

10. A seismic isolation method in accordance with claim 9, wherein the restraint wall is formed in the shape of a ring and disposed around the vibration-damping pad while being kept on an underside of the pressurizing plate.

11. A seismic isolation method in accordance with claim 9, wherein in the step of setting the vibration-damping pad, bonding a bottom-surface adhesive layer of the gel-like elastic body to the floor surface and in the step of joining the pressurizing plate, bonding the pressurizing plate to a top-surface adhesive layer of the gel-like elastic body.

12. A seismic isolation method in accordance with claim 8, wherein the step of restraining the leg section of the heavy object from moving laterally includes the steps of connecting a bolt provided in the holder to the leg section of the heavy object and adjusting the height of the leg section with a nut in threading engagement with the bolt.
